(19) United States
(12) Patent Application Publication
(10) Pub. No.: US 2008/0283783 A1
(43) Pub. Date: Nov. 20, 2008

(54) PROCESS AND DISPOSITIVE OF AUTOMATIC SEALING FOR PIPING EXITS

(76) Inventor: Hudson Gonzaga Perna, Sao Jose Dos Campos/SP (BR)

Correspondence Address: MCKEE, VOORHEES & SEASE, P.L.C., 801 GRAND AVENUE, SUITE 3200, DES MOINES, IA, 50309-2721, US

(21) Appl. No.: 11/750,614

(22) Filed: May 18, 2007

(51) Int. Cl. F16K 31/44

(52) U.S. Cl. 251/63.6

(57) ABSTRACT

This industrial patent has as purpose to facilitate the installation and/or removal process of equipments when these are in an exit of piping 6. The sealing device for piping exits including a device 1 that contains in its interior a valve 2 that will make the interruption of the flow contained in the piping 6 when there is not equipment 7 installed in the device 1. Therefore, the spring 5 pulls the head sealing 4. When the equipment 7 is settled in the device 1, it pushes the flange 3 that moves the sealing head 4, allowing the course of flow of the piping 6. The building of the automatic sealing device of piping exits (ASD) can be made with any material type, as well as in several geometric forms to guarantee the perfect sealing, as well as to assist the request of the fluid and gases type that passes thought the piping 6. In places where already has exit connections, it can be used only the element of sealing 2, introducing it in the existent connection.

The present invention has for objective the sealing of terminals or exits of piping, having the purpose to avoid the upsets when settling or removing equipments of the piping, where it is necessary the interruption of the piping line.

It is well-known the upset, when it is necessary to interrupt the flow of a line, mainly when the registration is distant and, most of the time, it is installed at places of difficult access. This situation is frequent in residences, hospitals, trade stores, industrial installations and anywhere we have a piping, driven gases and liquids, where usually a lid for retention of liquids and gases is used in the exits. To the retreat of the lid and installation of some equipment is necessary the interruption of the line, through the closing of a registration. The present invention has as purpose the automatic sealing of the piping exits through a device connected in the piping, not being more necessary the closing or interruption of supply of the line through the registration, facilitating the maintenance process and/or installation of equipments and connections.

### DESCRIPTION OF THE INVENTION

The automatic sealing device for piping exits (ASD) is a device that has internally a valve that blocks the exit of the piping flow if there is not the presence of a equipment or connection coupled in the device. In case some equipment or connection is introduced in the automatic sealing device for piping exits, this will allow the course of the flow of the piping.

The enclosed drawings show the automatic sealing device (ASD) for piping terminals, and:

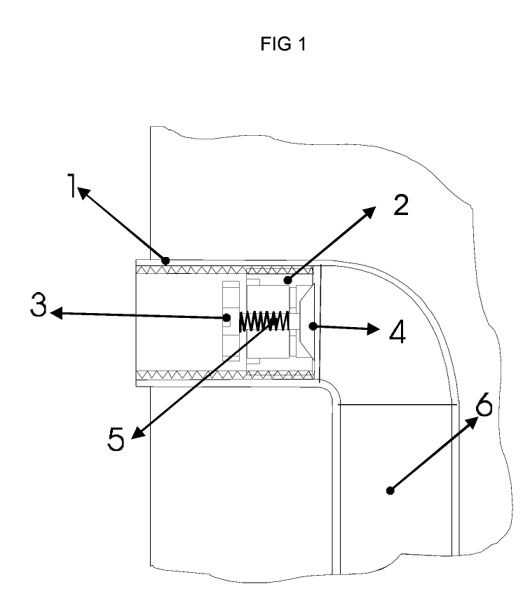

FIG. 1 shows the device acting as element of sealing of the piping.

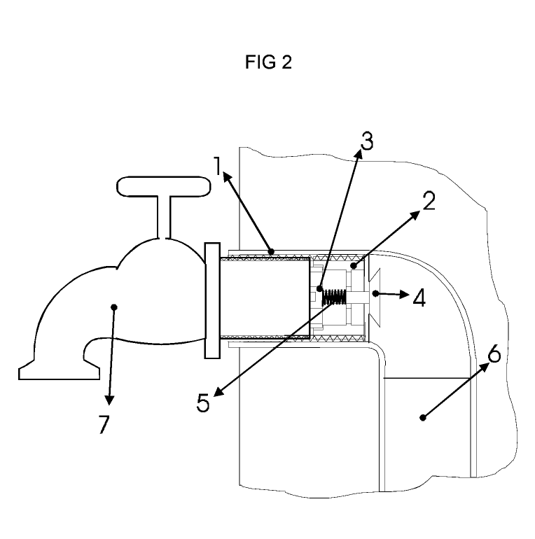

FIG. 2 shows the device acting as element of flow discharge of the piping, when an equipment is introduced in the mentioned device.

In conformity with the figures above related, the device accomplishes the sealing process according to the FIG. 1. In the device 1 the piping 6, the device is connected in the exits of the piping. The sealing happens when the head of sealing 4 is pulled by the spring 5 against the body of the valve 2.

FIG. 2 shows the process of the automatic sealing device for piping exit when the element 7 is introduced in the device 1 of the piping 6, where the element 7 pushes the flange 3, which moves the sealing head, allowing the course of liquids and gases contained in the piping 6. In this process the spring 5 is compressed.

The automatic sealing device for piping terminals (ASD) can be built of several geometric forms and materials in function of the request and of the liquid and gas type that circulates inside of the piping 6. The sealing head 4 can be circular, chamfered, spherical, flat or any other geometric form that can guarantee a better sealing, as well as to be composed by sealing rings, or sealing junctions, depending on the purpose. The device 1 can be set up inverted, where the pulling system of the sealing head 4 can be allocated on the internal side of the piping 6, opposite to the element 7 (equipment that can be faucets, manometers, clamps of hoses, or any other equipment). The automatic sealing device (ASD) can be applied in residential, industrial, automotive, naval, aeronautics, and nutritious piping, building site and in any segment of the society that it makes necessary, where the construction of the same depending on the request of each piping type and technical characteristics, substituting like this the current elbows, gloves and piping terminals.

In places where already has common connections of exit, not justifying its change, it can be used only the automatic element of sealing 2 introducing it through the internal threads of the connection.

1. Process and dispositive of automatic sealing for piping exits, including a device composed by the device 1, with a valve 2 positioned in its interior, characterized by the fact that the sealing head 4 interrupts the flow of the piping 6, when the element 7 is removed of the device 1, where the spring 5 pulls the sealing head 4 against the body of the valve 2. When the element 7 is introduced in the device 1, the same pushes the flange 3, compressing the spring 5, pushing the sealing head 4, allowing the course of liquids and gases of the piping 6.
